(19) United States
(12) Patent Application Publication
(10) Pub. No.: US 2004/0242396 A1
(43) Pub. Date: Dec. 2, 2004

(54) Matrix glass for cathode ray tube panel, panel for cathode ray tube, and process for the production of the panel

(76) Inventor: Yoichi Hachitani, Tokyo (JP)

Correspondence Address: NIXON & VANDERHYE, PC, 1100 N GLEBE ROAD, 8TH FLOOR, ARLINGTON, VA, 22201-4714, US

(21) Appl. No.: 10/350,336

(22) Filed: Jan. 24, 2003

(30) Foreign Application Priority Data
Jan. 25, 2002 (JP) 2002-17308

(51) Int. Cl. C03C 3/095; C03C 3/085

(52) U.S. Cl. 501/64; 501/69

(57) ABSTRACT

A matrix glass for a cathode ray tube panel having excellent melt shapability and properties necessary for a cathode ray tube panel and a panel for a cathode ray tube are provided. The matrix glass is for use as a cathode ray tube panel glass after chemical strengthening, comprises, by mol %, 45 to 70% of SiO₂, 0.1 to 20% of Al₂0₃, 7 to 20% of Li₂O, 0.1 to 20% of Na₂O, 1 to 13% of SrO, 0.1 to 3% of TiO₂, 0.1 to 10% of ZrO₂ and 0.01 to 1% of CeO₂, and (1) exhibits a temperature of 980° C. or lower at a viscosity of 10³ Pa·s or (2) contains none of MgO and CaO. The panel for a cathode ray tube is obtained by chemical strengthening of a shaped product formed of the above matrix glass.

### BACKGROUND OF THE INVENTION

1. Field of the Invention

The present invention relates to a matrix glass for a cathode ray tube panel, a panel for a cathode ray tube and a process for the production of the panel. More specifically, the present invention relates to a matrix glass for use in a cathode ray tube (to be sometimes abbreviated as “CRT” hereinafter) panel or a CRT projector panel, particularly, a matrix glass for a panel, which serves to decrease the thickness of the panel so that the weight of the panel can be decreased and that the brightness can be improved; a panel for a cathode ray tube, which is obtained by chemical strengthening of a shaped product formed of the above matrix glass; and a process for efficiently producing the panel.

2. Prior Art

A matrix glass for a CRT panel is required to have the property of absorbing and shutting off X rays generated by irradiation with electron beams and anti-coloring properties (anti-browning properties). In recent years, further, it is increasingly demanded to decrease the weight of the panel according to an increase in the size of CRTs. For use in a flat CRT having a panel portion made of a flat glass, which has appeared in recent years, the glass itself is required to have high strength unlike a conventional curved panel.

For satisfying the above requirement, the present inventor has already found a matrix glass for a CRT which matrix glass has a high Young's modulus and a matrix glass for a CRT which matrix glass has a high ion exchange efficiency and can give excellent mechanical strength by chemical strengthening (Japanese Patent Applications Nos. 2000-39096 and 2000-165917).

However, the above glasses have aimed mainly at improvements in Young's modulus and ion exchange efficiency, and there is yet room for improvement in the melt-shapability of the glasses which melt-shapability is an important factor for efficiently producing a panel for a cathode ray tube at high yields.

### SUMMARY OF THE INVENTION

Under the circumstances, it is an object of the present invention to provide a matrix glass for a cathode ray tube, which has excellent melt-shapability and properties required for a cathode ray tube panel; a cathode ray tube panel obtained from the above matrix glass; and a process for the production of the panel.

The present inventor has made diligent studies and as a result has found that a glass having a specific composition or having a specific composition and a specific melt viscosity can suit the above object as a matrix glass for a cathode ray tube panel, and that a desired cathode ray tube panel can be obtained by chemically strengthening a shaped product formed of the above matrix glass. The present invention has been completed on the basis of the above findings.

That is, the present invention provides;

(1) a matrix glass for a cathode ray tube, which is to be chemically strengthened for use as a cathode ray tube panel glass, which comprises, by mol %, 45 to 70% of SiO₂, 0.1 to 20% of Al₂O₃, 7 to 20% of Li₂O, 0.1 to 20% of Na₂O, 1 to 13% of SrO, 0.1 to 3% of TiO₂, 0.1 to 10% of ZrO₂ and 0.01 to 1% of CeO₂, and which exhibits a temperature of 980° C. or lower at a viscosity of 10³ Pa·s (to be referred to as “matrix glass I” hereinafter),

(2) a matrix glass for a cathode ray tube, which is to be chemically strengthened for use as a cathode ray tube panel glass, which comprises, by mol %, 45 to 70% of SiO₂, 0.1 to 20% of Al₂O₃, 7 to 20% of Li₂O, 0.1 to 20% of Na₂O, 1 to 13% of SrO, 0.1 to 3% of TiO₂, 0.1 to 10% of ZrO₂ and 0.01 to 1% of CeO₂, and which contains none of MgO and CaO (to be referred to as “matrix glass II” hereinafter),

(3) a matrix glass for a cathode ray tube panel as recited in the above (1) or (2), which has a liquidus temperature of at least 900° C.,

(4) a cathode ray tube panel which is a chemically strengthened product of a shaped product formed of the matrix glass recited in the above (1), (2) or (3), and

(5) a process for the production of a panel for a cathode ray tube, which comprises shaping the matrix glass recited in the above (1), (2) or (3) in a softened state into a shaped product having the form of a panel for a cathode ray tube, and then chemically strengthening the shaped product.

### BRIEF DESCRIPTION OF DRAWINGS

FIG. 1 is a graph showing viscosity curves of matrix glasses obtained in Example 1 and Comparative Examples 1 and 2.

### PREFERRED EMBODIMENTS OF THE INVENTION

The matrix glass for a cathode ray tube panel, provided by the present invention, is chemically strengthened, and the chemically strengthened glass is used as a cathode ray tube panel glass. The above matrix glass has excellent melt shapability and also has properties for a light-weight CRT panel. The above matrix glass includes two embodiments such as a matrix glass I and a matrix glass II.

First, the matrix glass I is a glass that contains, by mol %, 45 to 70% of SiO₂, 0.1 to 20% of Al₂O₃, 7 to 20% of Li₂O, 0.1 to 20% of Na₂O, 1 to 13% of SrO, 0.1 to 3% of TiO₂, 0.1 to 10% of ZrO₂ and 0.01 to 1% of CeO₂ and exhibits a temperature of 980° C. or lower at a viscosity of 10³ Pa·s.

Any conventional matrix glass for a CRT has a press-molding temperature around 1,100° C., and the viscosity thereof at such a temperature is 10² to 10³ Pa·s. In contrast, the temperature at which the matrix glass of the present invention exhibits a viscosity of 10³ Pa·s is 980° C. or lower, and the matrix glass of the present invention does not easily devitrify and has a low liquidus temperature, so that the shaping temperature thereof can be decreased. In view of impartation with various properties that will be explained later, the temperature at which the matrix glass exhibits a viscosity of 10³ Pa·s is preferably 880 to 980° C., more preferably 890 to 980° C., particularly preferably 890 to 960° C.

The matrix glass II is a glass having a composition containing, by mol %, 45 to 70% of SiO₂, 0.1 to 20% of Al₂O₃, 7 to 20% of Li₂O, 0.1 to 20% of Na₂O, 1 to 13% of SrO, 0.1 to 3% of TiO₂, 0.1 to 10% of ZrO₂ and 0.01 to 1% of CeO₂ and containing none of MgO and CaO.

MgO and CaO are components that increase the liquidus temperature of the glass. For improving the glass in shapability, it is desirable to decrease the liquidus temperature. In the matrix glass II, therefore, none of MgO and CaO is contained as a glass component. MgO and CaO are excluded, so that the liquidus temperature can be decreased, and the temperature at which the glass exhibits a viscosity of 10³ Pa·s can be adjusted to 980° C. or lower.

In the matrix glass of the present invention (including the matrix glass I and the matrix glass II; to be used in this sense hereinafter), it is preferred to adjust the liquidus temperature to 900° C. or lower, and in view of impartation with various properties to be explained later, it is more preferred to adjust the liquidus temperature to a temperature in the range of from 700 to 900° C.

In the chemical strengthening of the matrix glass of the present invention, the ion exchange efficiency is very high. For example, when the matrix glass of the present invention is treated for 4 hours, a compression stress layer formed substantially has a thickness of 100 μm or greater, and under the condition where it is scratched with a #150 sand paper, it exhibits a flexural strength of at least 300 MPa. A conventional physically strengthened glass shows a strength of approximately 70 MPa when scratched under the same condition, so that the matrix glass of the present invention exhibits a strength 4 times or higher as large as the strength of such a conventional glass.

The matrix glass of the present invention has a specific gravity of 2.5 to 2.8, which is equivalent to, or smaller than the specific gravity of a conventional glass. Further, the matrix glass of the present invention can be decreased in thickness, so that it is suitable for decreasing the weight. The specific gravity is more preferably at least 2.5 but less than 2.8.

Preferred ranges of components of the matrix glass for a CRT, provided by the present invention, will be discussed below. With regard to the content of each component below,% stands for mol %.

SiO₂ is a basic component of the glass. When the content of SiO₂ is less than 45%, the glass is poor in devitrification resistance and chemical durability. When it exceeds 70%, it is difficult to melt the glass. The content of SiO₂ is therefore limited to 45 to 70%. It is preferably 50 to 60%.

Al₂O₃ is a component for improving the glass in devitrification resistance and chemical durability. When the content of Al₂O₃ is less than 0.1%, no effect is produced. When it exceeds 20%, the glass is poor in devitrification resistance. The content of Al₂O₃ is therefore limited to 0.1 to 20%. It is preferably 5 to 15%.

Li₂O is a component that undergoes ion-exchange in a glass surface layer portion mainly with Na ion in an ion-exchange treatment bath and chemically strengthens the glass. When the content of Li₂O is less than 7%, the above effect is small. When it exceeds 20%, the glass is deteriorated in devitrification resistance and chemical durability. The content of Li₂O is therefore limited to 7 to 20%. Li₂O is also a component that decreases an X-ray absorption coefficient, so that the content thereof is preferably 10 to 15%.

Na₂O is a component that undergoes ion-exchange in a glass surface layer portion with K ion in a ion-exchange treatment bath and chemically strengthens the glass. When the content of Na₂O is less than 0.1%, the above effect is not produced. When it exceeds 20%, the glass is decreased in devitrification resistance and chemical durability. The content of Na₂O is therefore limited to 0.1 to 20%. Na₂O is also a component that decreases an X-ray absorption coefficient, so that the content thereof is preferably 5 to 15%.

SrO is a component that has a remarkable effect on improving the X-ray absorption coefficient. When the content of SrO is less than 1%, the above effect is small. When it exceeds 15%, the Young's modulus of the glass is low. The content of SrO is therefore limited to 1 to 15%. It is preferably 5 to 10%.

TiO₂ is a component that prevents coloring of the glass caused with ultraviolet light and improves the glass in Young's modulus and X-ray absorption coefficient. When the content of TiO₂ is less than 0.1%, the above effects are not produced. When it exceeds 3%, the glass is liable to be colored in yellow. The content of TiO₂ is therefore limited to 0.1 to 3%. It is preferably in the range of from 0.1 to 1%.

ZrO₂ is also a component that improves the glass in Young's modulus and X-ray absorption coefficient. When the content of ZrO₂ is less than 0.1%, the above effects are not produced. When it exceeds 10%, the glass is poor in devitrification resistance. The content of ZrO₂ is therefore limited to 0.1 to 10%. It is preferably 1 to 5%.

CeO₂ is a component that prevents coloring caused by electron beams. When the content of CeO₂ is less than 0.01%, the above effect is not produced. When it exceeds 1%, the glass is liable to be colored in yellow. The content of CeO₂ is therefore limited to 0.01 to 1%.

The above components are essential components for the matrix glass of the present invention. Optional components will be explained below.

K₂O may be added since it is a component that prevents coloring caused by X ray. However, the content of K₂O exceeds 8%, the ion-exchange efficiency tends to decrease, so that the content of K₂O is preferably 8% or less, more preferably 0 to 5%.

MgO and CaO are as explained with respect to the matrix glass II. It is essential that the matrix glass I should not contain them, either.

Sb₂O₃ may be incorporated as a clarifier. When Sb₂O₃ is externally added in an amount exceeding 1% based on the total amount of the above mentioned glass components, it is difficult to clarify the glass. The content of Sb₂O₃ based on the total amount of the above mentioned glass components is therefore adjusted to 0 to 2%, preferably 0.01 to 0.5%.

In addition to these, BaO, ZnO, La₂O₃, B₂O₃, Y₂O₃, Nb₂O₅, SnO₂ and F may be added as required for improving the glass in meltability, clarification, thermal expansion coefficient, X-ray absorption coefficient and Young's modulus or for adjusting the ion-exchange rate and preventing browning.

Further, at least one component or a plurality of components selected from Ni, Co, Fe, Mn, V, Cu and Cr may be used as required for adjusting the transmittance of the glass.

The matrix glass of the present invention can be imparted with the above more preferred properties by combining the above preferred content ranges or the above more preferred content ranges. Above all, the matrix glass of the present invention is particularly preferably a glass that contains, by mol %, 50 to 60% of SiO₂, 5 to 15% of Al₂O₃, 10 to 15% of Li₂O, 5 to 15% of Na₂O, 5 to 10% of SrO, 0.1 to 1% of TiO₂, 1 to 5% of ZrO₂, 0.01 to 1% of CeO₂ and 0 to 5% of K₂O and additionally contains 0.01 to 0.5%, based on the total amount of the glass components, of Sb₂O₃.

Further, in the matrix glass of the present invention, preferred is a glass in which the total content of SiO₂, Al₂O₃, Li₂O, Na₂O, SrO, BaO, TiO₂, ZrO₂ and CeO₂, excluding Sb₂O₃, is at least 95%, a glass in which the above total content is at least 98% is more preferred, and a glass in which the above total content is 100% is still more preferred.

Further, in the matrix glass of the present invention, also preferred is a glass in which the total content of SiO₂, Al₂O₃, Li₂O, Na₂O, SrO, TiO₂, ZrO₂ and CeO₂, excluding Sb₂O₃, is at least 95%, a glass in which the above total content is at least 98% is also more preferred, and a glass in which the above total content is 100% is also still more preferred.

The method of producing the matrix glass of the present invention is not specially limited, and a conventional method can be employed. For example, oxides, hydroxides, carbonates, nitrates, chlorides, sulfides, and the like are used as glass raw materials as required, weighed so as to prepare a desired composition and mixed to obtain a formulated material. The formulated material is placed in a heat-resistant crucible, melted at a temperature of approximately 1,300 to 1,450° C., stirred and clarified to prepare a homogeneous molten glass. Then, the molten glass is cast into a molding frame to form a glass block or press-molded in the form of a CRT. The glass is transferred to a furnace heated at a temperature around an annealing point of the glass and cooled to room temperature. The glass obtained after the annealing is polished.

The panel for a cathode ray tube, provided by the present invention, is obtained by chemical strengthening of a molded (shaped) product formed of the above matrix glass, and the molded product is chemically strengthened by subjecting the polished molded product to ion-exchange in an alkali molten salt. The above ion-exchange can be carried out by employing the same treatment as the ion- exchange treatment employed for a conventional chemically strengthened glass. As a composition of the molten salt, a known composition is selected depending upon the glass composition. The composition of the molten salt effects to the coloring caused by X ray. After the molded product is immersed in the molten salt for a predetermined time period, the molded product is taken out and washed.

A stress-strain layer can be measured for a thickness by a Babinet compensation method or a method using a polarization microscope. For a Babinet compensation method using a precision strain meter, a commercially available measuring unit can be used. In the method using a polarization microscope, a glass sample is cut at right angles with an ion-exchanged surface, cross-sections of the glass are polished such that the glass has a thickness of 0.5 mm or smaller, polarized light is allowed to enter the polished surface in the direction at right angles with the polished surface, and the polished surface is observed at crossed Nicols through a polarization microscope. In a strengthened glass, a strain layer is formed in the vicinity of a surface, so that the strain layer can be measured for a thickness by measuring a distance from the surface to a portion where a change occurs in brightness or a color.

The matrix glass of the present invention is suitable for obtaining a strengthened glass by chemical strengthening without carrying out physical strengthening. A chemically strengthened glass and a physically strengthened glass can be distinguished from each other by inspecting a distribution of metal ions contained in the vicinity of a glass panel surface. Distributions of depths of metal ion having a larger ionic radius (e.g., alkali metal ion) and a metal ion having a smaller ionic radius (e.g., alkali metal ion) are studied. If (density of metal ion having a larger ionic radius)/(density of metal ion having a smaller ionic radius) is greater in a portion closer to the surface than in a deep portion of a glass (portion positioned ½of thickness of the glass depth), and if the glass has a flexural strength in the range specified in the present invention, it is seen that the glass is chemically strengthened by ion-exchange.

The process for the production of a panel for a cathode ray tube, provided by the present invention, will be explained below.

First, a pair of mold members for transferring an intended panel form is provided, and a molten glass (matrix glass) in a desired amount is supplied to molding surfaces of the mold members. Then, while the glass is in a softened state, the glass is pressed with a pair of the mold members to transfer the mold form to the glass, whereby the matrix glass is molded in an intended form. After the temperature of the molded glass decreases to a temperature around a glass transition temperature, the molded product is taken out of the mold and annealed to remove a distortion. In the above step, it is required to supply the matrix glass to the mold in a state where the matrix glass is press-moldable without causing the glass to devitrify. By the use of the above matrix glass that exhibits a temperature of 980° C. or lower at a viscosity of 10³ Pa·s, the above requirement can be easily fulfilled. Further, by the use of the matrix glass that further has a liquidus temperature of 900° C. or lower, the press-molding can be further easily carried out while preventing the devitrification.

In the above process, the molten glass is supplied to the mold. However, a desired amount of the glass may be heated to soften it, supplied to the mold, press-molded and annealed.

The annealed glass molded product is chemically strengthened according to the already explained method, to form a cathode ray tube panel. The surface of the annealed glass molded product may be lapped and polished as required before the chemical strengthening.

The thus-obtained panel is used to assemble a cathode ray tube according to a known method.

### EXAMPLES

The present invention will be explained with reference to Examples hereinafter, while the present invention shall not at all be limited by these Examples.

### Examples 1-4 and Comparative Examples 1 and 2

Materials such as oxides, hydroxides, carbonates, nitrates, chlorides, sulfates, etc., were weighed so as to obtain a composition shown in Table 1 and mixed to prepare a formulated raw material. The formulated raw material is placed in a heat-resistant crucible, heated to 1,400° C., melted and stirred to homogenize and clarify the glass. Then, the glass was cast into a mold. After solidified, the glass was transferred to an electric furnace that was heated beforehand to a temperature around the annealing point of the glass, and the glass was annealed.

A 65×10×1 mm double-surface polished sample was prepared from the thus-obtained glass block and subjected to an ion-exchange treatment as follows. A molten salt having a composition of NaNO₃:KNO₃=4:6 as a weigh ratio was used as a molten salt, and the above glass sample was immersed in the molten salt for a predetermined period of time and then taken out and washed. In considering the prevention of glass coloring during electron beam irradiation, it is preferable that the weight ratio of NaNo₃:KNO₃ in the molten salt is controlled 2:8 to 1:9.

Table 1 shows glass compositions and data of various measurements. The content of Sb₂O₃ in Table 1 refers to a content externally added based on the total amount of the glass components. Further, glass sample obtained as described above were measured for physical property values according to the following methods.

X-ray absorption coefficient: X ray having a wavelength of 0.06 nm was caused to enter a glass and measured for a transmitted ray amount in a position 50 mm far from the opposite surface of the glass. An absorption coefficient was calculated on the basis of the obtained data.

Scratch resistance: One surface of an ion-exchanged glass sample was uniformly scratched with a JIS standard #150 sand paper, and while a load was applied to exert a tensile stress on the scratched surface, the glass sample was measured according to a three-point bending test of JIS-R1601.

Thickness of stress-strain layer: A cross-section of an ion-exchanged glass sample was polished and measured with a polarization microscope.

Viscosity of glass: A glass sample was measured according to the method of JIS Z8803 using a co-axial double cylindrical rotation viscometer.

Liquidus temperature: A glass sample was held in a devitrification test furnace having a temperature gradient of from 400 to 1,100° C. for 1 hour, and the glass sample was observed through a microscope of 80 magnifications to see whether or not a crystal was present.

Thermal expansion coefficient: A glass sample was measured with a thermomechanical analyzer (TMA).

Young's modulus: A glass sample was measured for sonic velocities of transverse wave and longitudinal wave propagating through the glass with a sing-around method sonic velocity measuring apparatus.

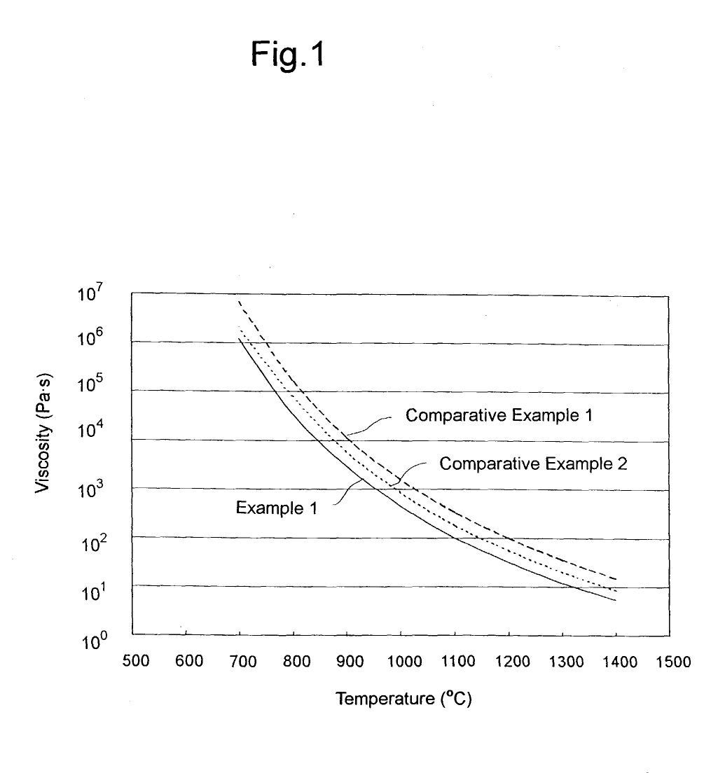

FIG. 1 shows viscosity curves of glass samples of Example 1 and Comparative Examples 1 and 2.

TABLE 1

| Composition | | | | | | | |
|---|---|---|---|---|---|---|---|
| (mol %) | | Ex. 1 | Ex. 2 | Ex. 3 | Ex. 4 | CEx. 1 | CEx. 2 |
| | SiO₂ | 57.5 | 65.6 | 54.4 | 56.5 | 71.5 | 71.6 |
| | Al₂O₃ | 10.0 | 2.0 | 12.0 | 10.0 | 1.5 | 1.5 |
| | Li₂O | 13.0 | 12.0 | 13.0 | 14.0 | 0.0 | 2.3 |
| Glass | Na₂O | 10.0 | 9.0 | 8.0 | 10.0 | 9.0 | 5.6 |
| | K₂O | 0.0 | 0.0 | 0.0 | 0.0 | 6.0 | 6.6 |
| Com- | MgO | 0.0 | 0.0 | 0.0 | 0.0 | 0.0 | 0.0 |
| po- | CaO | 0.0 | 0.0 | 0.0 | 0.0 | 0.0 | 0.0 |
| sition | SrO | 6.0 | 7.0 | 9.0 | 5.0 | 6.2 | 6.7 |
| (mol | BaO | 0.0 | 0.0 | 0.0 | 1.0 | 4.1 | 3.6 |
| %) | TiO₂ | 0.4 | 0.3 | 0.5 | 0.4 | 0.5 | 0.4 |
| | ZrO₂ | 3.0 | 4.0 | 3.0 | 3.0 | 1.1 | 1.5 |
| | CeO₂ | 0.1 | 0.1 | 0.1 | 0.1 | 0.1 | 0.2 |
| | Sb₂O₃* | 0.01 | 0.01 | 0.01 | 0.01 | 0.01 | 0.01 |
| | Total | 100 | 100 | 100 | 100 | 100 | 100 |

| | | | | | | |
|---|---|---|---|---|---|---|
| X-ray absorp- | 29 | 29 | 29 | 29 | 29 | 29 |
| tion coefficient | | | | | | |
| (cm⁻¹) | | | | | | |
| Specific gravity | 2.7 | 2.7 | 2.7 | 2.7 | 2.8 | 2.8 |
| Thermal expan- | 102 | 104 | 101 | 100 | 100 | 100 |
| sion coefficient | | | | | | |
| (×10⁻⁷/° C.) | | | | | | |
| Young's | 89 | 90 | 90 | 88 | 77 | 77 |
| modulus (GPa) | | | | | | |
| Liquidus temp- | 890 | 770 | 850 | 810 | 950 | 930 |
| erature (° C.) | | | | | | |
| Temperature | 950 | 900 | 950 | 950 | 1050 | 1000 |
| (° C.) at a vis- | | | | | | |
| cosity of 10³ | | | | | | |
| Pa · s. | | | | | | |
| Ion-exchange | 400 | 380 | 400 | 420 | 440 | 440 |
| temperature | | | | | | |
| (° C.) | | | | | | |
| Time period for | 4 | 4 | 4 | 4 | 4 | 4 |
| ion-exchange | | | | | | |
| (hour) | | | | | | |
| Depth of stress- | 70 | 80 | 80 | 80 | 20 | 20 |
| strain layer | | | | | | |
| (μm) | | | | | | |
| Scratch resist- | 400 | 380 | 350 | 400 | 70 | 70 |
| ance (MPa) | | | | | | |

Ex. = Example, CEx. = Comparative Example
*externally added based on total glass amount

The matrix glasses obtained in Examples 1 to 4 had an X-ray absorption coefficient of 28 or more and a scratch resistance of 300 MPa or more. Further, the temperature at which these glasses exhibit a viscosity of 10³ Pa·s is lower than the temperature of a conventional glass by 50 to 100° C., so that these glasses are excellent in melt-shapability. As described above, glasses having excellent melt shapability and having properties necessary for a cathode ray tube panel were obtained.

### Example 5

Molten glasses that were to give the matrix glasses in Examples 1 to 4 were prepared, and each glass having a weight equivalent to the weight of a panel was respectively supplied onto a molding surface of a mold. Each molten glass was press-molded with a pair of mold members as described already. Then, each molded product was cooled to a temperature at which no deformation took place, transferred to an annealing furnace and annealed to remove a distortion. The molded products from which the distortion had been removed were chemically strengthened by the above-described method, to produce cathode ray tube glass panels.

The matrix glasses used are excellent in devitrification resistance and melt shapability, and panels are therefore easily produced while preventing devitrification, so that excellent products can be produced with high productivity.

### Effect of the Invention

According to the present invention, there can be provided a matrix glass for a cathode ray tube panel, which has excellent melt shapability and properties necessary for a cathode ray tube panel, a cathode ray tube panel obtained by chemical strengthening of the above matrix glass, and a process for the production of the above panel.

What is claimed is:

1. A matrix glass for a cathode ray tube, which is to be chemically strengthened for use as a cathode ray tube panel glass, which comprises, by mol %, 45 to 70% of SiO₂, 0.1 to 20% of Al₂O₃, 7 to 20% of Li₂O, 0.1 to 20% of Na₂O, 1 to 13% of SrO, 0.1 to 3% of TiO₂, 0.1 to 10% of ZrO₂ and 0.01 to 1% of CeO₂, and which exhibits a temperature of 980° C. or lower at a viscosity of 10³ Pa·s.

2. A matrix glass for a cathode ray tube, which is to be chemically strengthened for use as a cathode ray tube panel glass, which comprises, by mol %, 45 to 70% of SiO₂, 0.1 to 20% of Al₂O₃, 7 to 20% of Li₂O, 0.1 to 20% of Na₂O, 1 to 13% of SrO, 0.1 to 3% of TiO₂, 0.1 to 10% of ZrO₂ and 0.01 to 1% of CeO₂, and which contains none of MgO and CaO

3. The matrix glass of claim 1 or 2, which has a liquidus temperature of 900° C. or lower.

4. A panel for a cathode ray tube, which is a chemically strengthened product of a shaped product formed of the matrix glass recited in claim 1, 2 or 3.

5. A process for the production of a panel for a cathode ray tube, which comprises shaping the matrix glass recited in claim 1, 2 or 3 in a softened state into a shaped product having the form of a panel for a cathode ray tube, and then chemically strengthening the shaped product.
